(19) United States
(12) Patent Application Publication
(10) Pub. No.: US 2014/0156891 A1
(43) Pub. Date: Jun. 5, 2014

(54) SYSTEMS AND METHODS FOR AUTOMATICALLY GENERATING MASTER-SLAVE LATCH STRUCTURES WITH FULLY REGISTERED FLOW CONTROL

(71) Applicant: NVIDIA Corporation, (US)

(72) Inventor: Robert A. Alfieri, Chapel Hill, NC (US)

(73) Assignee: NVIDIA CORPORATION, Santa Clara, CA (US)

(21) Appl. No.: 13/693,869

(22) Filed: Dec. 4, 2012

(51) Int. Cl. G06F 13/362

(52) U.S. Cl. CPC G06F 13/362
USPC 710/110

(57) ABSTRACT

A method for automatically generating master-slave latch structures is disclosed. A method includes, from another logic synthesis system that invokes a logic synthesis system for generating master-slave latch structures, accessing high level design descriptions of a master-slave latch structure that indicate a fully registered flow control structure design and based on the high level design descriptions, generating a master-slave latch structure design to include at least one master-slave latch pair.

### CROSS-REFERENCE TO RELATED APPLICATION

This application is related to U.S. patent application Ser. No. ______, filed ______ 2012, attorney docket no. ______, entitled “SEQUENTIAL ACCESS MEMORY USING MASTER-SLAVE LATCH PAIRS AND METHOD OF OPERATING” assigned to the assignee of the present disclosure, which is hereby incorporated herein by reference in its entirety.

### BACKGROUND

In electronics, logic synthesis is a process by which a description of a circuit's operation, design and organization is converted into a design implementation that comprises logic gates. Common examples of this process involve the synthesis of designs expressed using hardware description languages (HDLs), including very high speed integrated circuit HDL (VHDL) and Verilog, typically at the register transfer level (RTL), that describe a circuit's operation, design and organization. Typically the synthesis tool takes RTL code, a standard cell library and user defined constraints and produces a gate level representation of the design. In producing the representation, it attempts to best meet the user defined constraints. Logic synthesis is one aspect of electronic design automation (EDA).

Logic synthesis systems can be configured to generate specific types of circuits. For example, a conventional synthesis system that is configured to generate first-in-first out (FIFO) buffers, generates fully registered receiver side circuits and fully registered sender side circuits, for providing flow control as is shown in FIGS. 1 and 2 respectively, based on user defined descriptions. To best meet the user defined descriptions, the conventional synthesis system, is programmed to generate the fully registered sender and receiver side flow control systems to include flip-flop pairs and a multiplexor, arranged as shown in FIGS. 1 and 2.

In another example, a conventional synthesis system that is configured to generate random access memory (RAM) arrays, generates a fully registered 8-deep latch array (includes 8 latches) as is shown in FIG. 3 based on user defined descriptions. To best meet the user defined descriptions, this conventional synthesis system, is programmed to generate the 8-deep latch array using a master flip-flop that feed into N rows of slave latches, followed by an N-to-1 multiplexor arranged as is shown in FIG. 3. The 8-deep latch array shown in FIG. 3 includes a built-in self-test (BIST) structure (not shown) that can be used to test the array.

Circuit design characteristics that are used to adjudge the merits of circuit designs that are generated by logic synthesis systems include testability, circuit area, timing and power. These characteristics can be dependent upon the components that are used to implement the designs. Synthesis systems such as those that generate the designs shown in FIGS. 1-3 rely on the use of a master flip-flop and an N-to-1 readout multiplexor for implementation purposes. The use of such components can have design consequences. For example, the scale of a design that uses a master flip-flop and an N-to-1 readout multiplexor is limited by the amount of space that the master flop and the N-to-1 readout multiplexor occupy. In addition, such designs have timing limitations that are attributable to their use of a flip-flop and an N-to-1 multiplexor. Accordingly, a shortcoming of the designs for fully registered flow control devices that are generated by conventional logic gate synthesis systems include their dependence on the use of a flip-flop and a readout multiplexor in their implementation.

### SUMMARY

Some conventional logic gate synthesis systems rely on the use of a flip-flop and a readout multiplexor, that can occupy excessive space, in their implementation of fully registered flow control devices. A logic gate synthesis system that uses master-slave latch pairs as opposed to flip flops is disclosed that addresses these shortcomings. However, the claimed embodiments are not limited to implementations that address any or all of the aforementioned shortcomings.

In one embodiment, the logic gate synthesis system that generates the master-slave latch structures is invoked from another logic gate synthesis system when that system determines that fully-registered flow control is indicated in configuration parameter settings. In one embodiment, the master-slave latch structure that is generated utilizes latches as opposed to the flip flops used in designs generated by conventional synthesis systems. The advantageous elimination of flip flops saves area and latency as compared to conventional designs. The latch structure can be scan-tested and thus does not require a test harness which also saves area and improves timing. In addition, the read-out multiplexor used can be smaller because it can be N/2 to 1 instead of N to 1.

In one embodiment, a method for automatically generating master-slave latch structures is disclosed. The method includes, from another logic synthesis system that invokes a logic synthesis system for generating master-slave latch structures, accessing high level design descriptions of a master-slave latch structure that indicate a fully registered flow control structure design and based on the high level design descriptions, generating a master-slave latch structure design to include at least one master-slave latch pair.

In one embodiment, in a logic synthesis platform, a computer implemented method for automatically generating a master-slave latch structure design is disclosed. The method includes receiving at a first logic synthesis system, high level design descriptions for a master-slave latch structure design that indicate a fully registered flow control structure design, invoking from said first logic synthesis system, a second logic synthesis system based on a determination that fully registered flow control is involved, accessing from the first logic synthesis system the high level design descriptions and based on said high level design descriptions, automatically generating the master-slave latch structure design. The master-slave latch structure design is generated to include at least one master-slave latch pair.

In one embodiment, a computer system is disclosed. The computer system includes memory, at least one processer and a display component. The at least one processer executes a method for automatically generating a master-slave latch structure design. The method includes, from another logic synthesis system that invokes a logic synthesis system for generating master-slave latch structures, accessing high level design descriptions of a master-slave latch structure that indicate a fully registered flow control structure design and based on the high level design descriptions, generating a master-slave latch structure design to include at least one master-slave latch pair.

### BRIEF DESCRIPTION OF THE DRAWINGS

The embodiments of the present invention, together with further advantages thereof, may best be understood by reference to the following description taken in conjunction with the accompanying drawings in which:

FIG. 1 shows a fully registered receiver side flow control circuit that is generated by a conventional logic synthesis system.

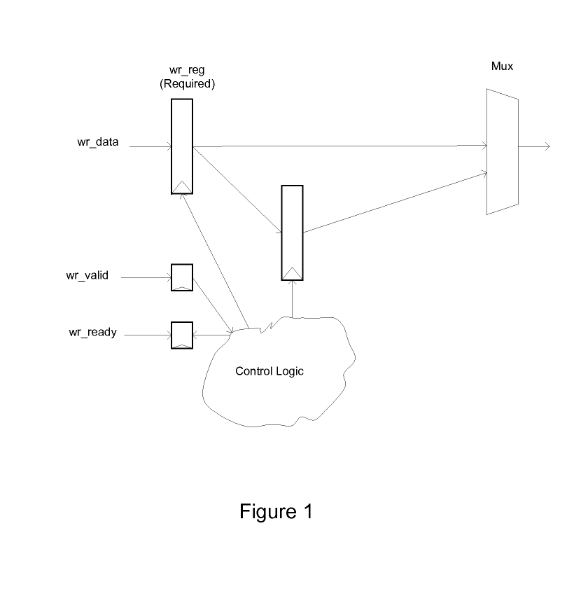

FIG. 2 shows a fully registered sender side flow control circuit that is generated by a conventional logic synthesis system.

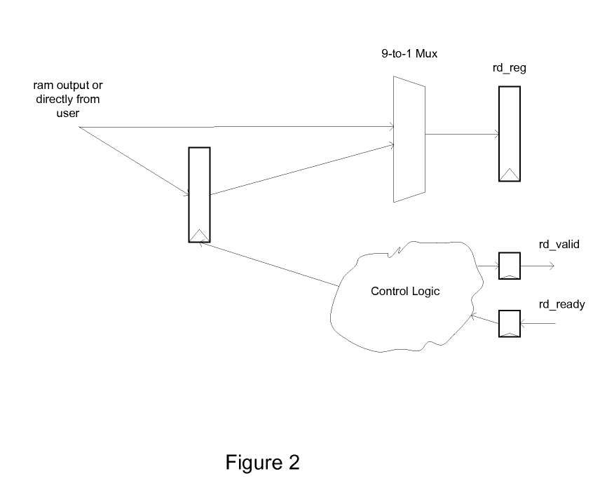

FIG. 3 shows a fully registered 8-deep latch array (includes 8 latches) that is generated by a conventional logic synthesis system.

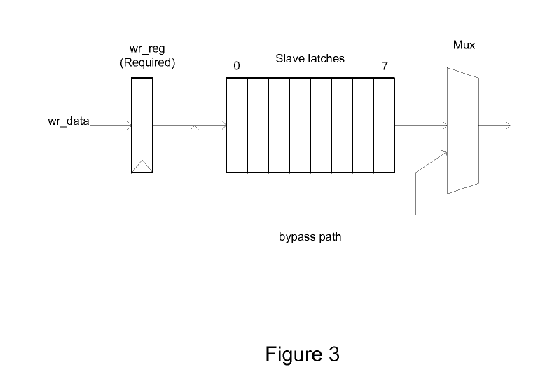

FIG. 4A shows an exemplary operating environment of a system for automatically generating master-slave latch structures according to one embodiment.

FIG. 4B illustrates the generation of a master-slave pair, with the master implementing a fully registered read side (e.g., wr_reg) and the slave implementing a 1-deep RAM according to one embodiment.

FIG. 4C shows a RAM using N/2 master-slave pairs and an N/2 to 1 read-out multiplexer according to one embodiment.

FIG. 4D illustrates exemplary operations performed by system for automatically generating master-slave latch structures according to one embodiment.

FIG. 5 shows components of a system for automatically generating master-slave latch structures according to one embodiment.

FIG. 6 shows a flowchart of exemplary operations performed in a method for generating master-slave latch structures according to one embodiment.

FIG. 7 shows an exemplary computing platform according to one embodiment.

It should be noted that like reference numbers refer to like elements in the figures.

### DETAILED DESCRIPTION

Although the present invention has been described in connection with one embodiment, the invention is not intended to be limited to the specific forms set forth herein. On the contrary, it is intended to cover such alternatives, modifications, and equivalents as can be reasonably included within the scope of the invention as defined by the appended claims.

In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

References within the specification to “one embodiment” or “an embodiment” are intended to indicate that a particular feature, structure, or characteristic described in connection with the embodiment is included in at least one embodiment of the present invention. The appearance of the phrase “in one embodiment” in various places within the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals of a computer readable storage medium and are capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing” or “invoking” or “generating” or “providing” or the like, refer to the action and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices.

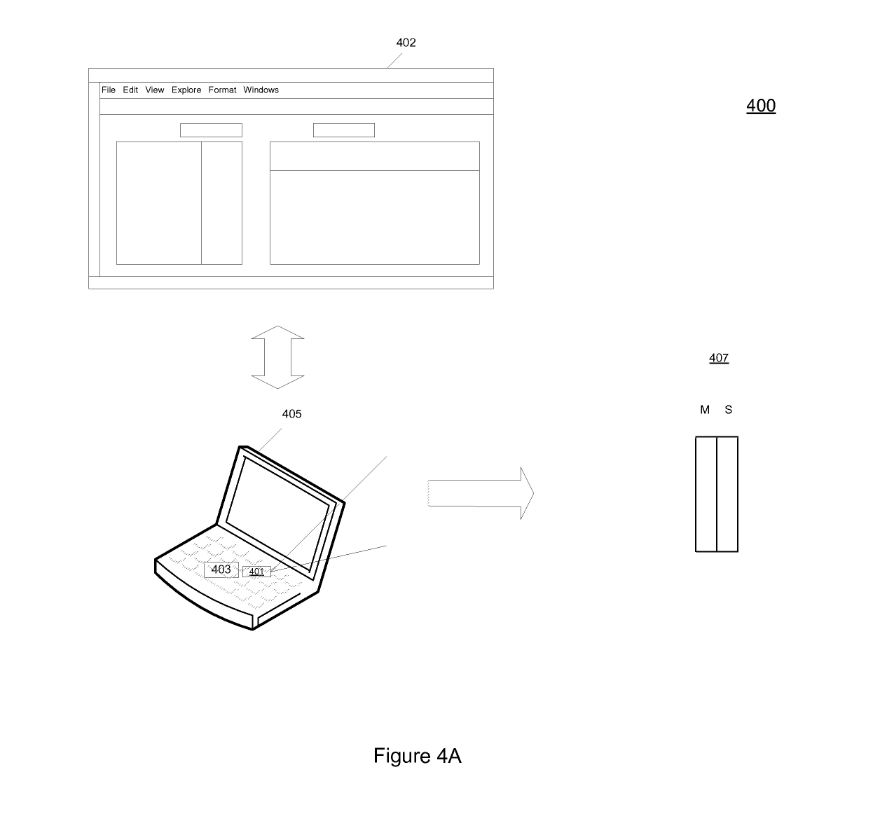

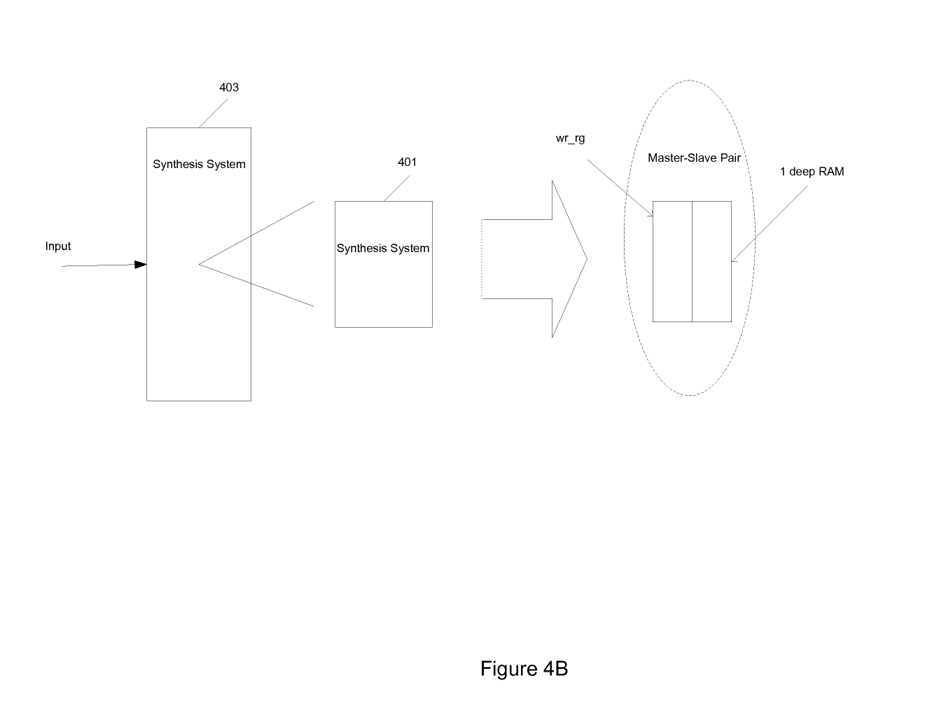

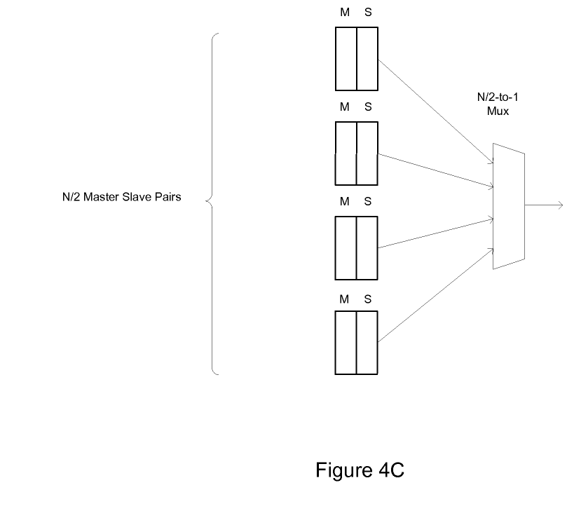

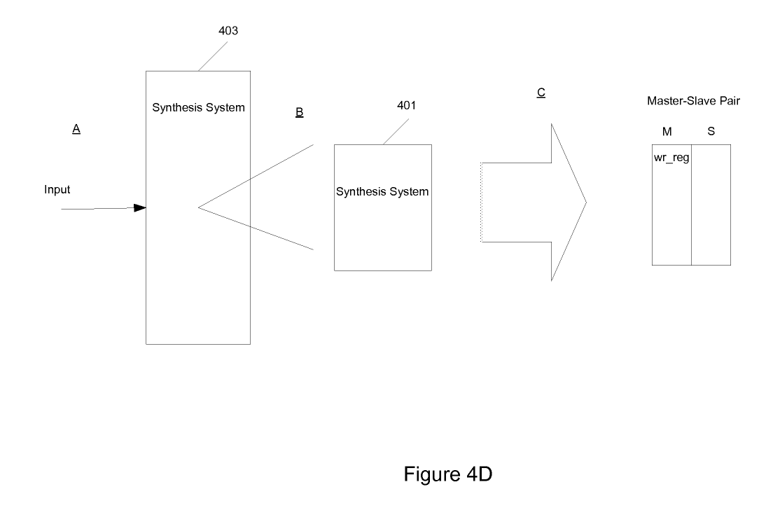

FIG. 4A shows an exemplary operating environment 400 of a system 401 for automatically generating master-slave latch structures according to one embodiment. In one embodiment, system 401 is a logic gate synthesis system that accesses high level logic circuit design inputs and generates a gate level representation of a design that is implemented using master-slave latch pairs. In exemplary embodiments, system 401 can be invoked from other logic gate synthesis systems or components. FIG. 4A shows system 401, other synthesis systems or components 403, computing platform 405 and design implementation 407.

Referring to FIG. 4A, based on high level design description inputs, system 401 generates a design implementation 407 that comprises master-slave latch pairs. In one embodiment, the high level design description inputs can include but are not limited to RTL code of the design, constraints on timing, area, etc., and a standard cell library. In one embodiment, the high level design description inputs can initially be provided as an input to other synthesis systems or components 403, via computing platform 405 (e.g., a computer system), upon which other synthesis systems or components 403 operate. In particular, the high level design description inputs can be input into other synthesis systems or components via GUI 402. Furthermore, in one embodiment, the invoking of synthesis system 401 is performed via a call from other synthesis systems or components 403. In one embodiment, system 401 can actually be a part of other synthesis systems or components 403. In another embodiment, system 401 can be separate from other synthesis systems or components 403 but operate cooperatively therewith.

Other synthesis systems or components 403 generate design implementations comprising logic gates. Other synthesis systems or components 403 can include but are not limited to a RAM generating synthesis tool, a FIFO generating synthesis tool, a retiming tool and a pipe plugin tool. In one embodiment, other synthesis systems or components 403 is configured to invoke system 401 when a fully registered flow control circuit (e.g., such as a FIFO) is indicated for a design. In one embodiment, the invoking of synthesis system 401 can be based on the high level design description inputs discussed above. In such situations, system 401 is invoked whereupon a design that is implemented with master-slave latch pairs is generated.

In one embodiment, other synthesis systems or components 403 invoke system 401 when implementing, interface senders and receivers, a fully-registered read side (e.g., rd_reg) and sequential memories. In one embodiment, other synthesis systems or components 403 (if a retiming synthesis system) can invoke system 401 to generate implicit retiming stages. In one embodiment, other synthesis systems or components 403 (e.g., a pipe plugin) can invoke system 401 to generate an explicit retiming stage.

In one embodiment, for interface senders and receivers, system 401 generates a master-slave pair, with the master implementing a fully registered write side (e.g., wr_reg) and the slave implementing a 1-deep RAM as is shown in FIG. 4B. If the depth is N where N>1 and the flow control device is synchronous and single-threaded, then system 401 generates the RAM using N/2 master-slave pairs and an N/2 to 1 read-out mux as is shown in FIG. 4C. This structure is efficient and can be tested using automatic test pattern generation (ATPG). In one embodiment, if a design involves the use of a bypass register or a retiming stage (either implicit or explicit), system 401 generates a master-slave pair.

In exemplary embodiments, system 401 uses a master-slave latch pair in places where fully-registered flow control is indicated. In one embodiment, system 401 generates the master-slave latch pair and the associated flow control logic. In controlling the master-slave latch pair, the clock is gated (including on the master though the master remains open or transparent) until new data arrives. In one embodiment, the use of master-slave latch pairs as opposed to flip-flops saves area. Moreover, such structures can be scan-tested and thus do not require a test harness which saves area and improves timing.

### Operation

FIG. 4D illustrates operations performed by system for automatically generating master-slave latch structures according to one embodiment. These operations are illustrated for purposes of clarity and brevity. It should be appreciated that other operations not illustrated in FIG. 4D can be performed in accordance with one embodiment.

At A, other synthesis systems or components 403 receive high level design description inputs for use in generating a master-slave latch structure design (e.g., flow control circuit design). In one embodiment, the high level design description inputs can indicate that the design is to include fully registered flow control.

At B, other synthesis systems or components 403 based on a determination that fully registered flow control design is involved, invokes system 401. Other synthesis system or component 403 which invokes synthesis system 401 can include but is not limited to include a RAM generating synthesis tool, a FIFO generating synthesis tool, a retiming tool and a pipe plugin tool.

At C, system 401, based on the high level design description input, generates a master-slave structure that provides fully registered flow control and that comprises at least one a master-slave latch pair.

### Exemplary Configuration Options

In one embodiment, configuration can be set to determine the logic gates that are used to implement a design by other synthesis systems or components 403 and system 401. For example, in one embodiment, when the total bits in a proposed RAM design is less than or equal to a predetermined cutoff value, other synthesis systems or components 403 can be configured to choose a flip-flop option if the flip-flop option is compatible with other options. In exemplary embodiments, the default cutoff value for total bits in the proposed RAM design can be 16. In other embodiments, the default cutoff value for total bits in the proposed RAM design can be a value other than 16.

In one embodiment, when the width of a proposed RAM design is less than or equal to a predetermined cutoff value and the depth of the proposed RAM design is less than or equal to the predetermined cutoff value, other synthesis systems or components 403 can be configured to choose a flip-flop option to construct the RAM if the flip-flop option is compatible with other options. In one embodiment, the default cutoff value for the width of the proposed RAM design can be 2 to 32. In other embodiments, the default cutoff value for total bits in the proposed RAM design can be a value other than 2 to 32.

In one embodiment, when the depth of a proposed RAM design is less than or equal a predetermined cutoff value other synthesis systems or components 403 can be configured to use a flip-flop option to construct the proposed RAM design if flip-flops are compatible with other options. In one embodiment, the default cutoff value for the depth of the proposed RAM design can be −1 (e.g., disabled). In other embodiments, the default cutoff value for depth of the proposed RAM design can be a value other than −1. In one embodiment, when the depth of the proposed RAM design is less than or equal to the predetermined cutoff, and a FIFO optimized latch array is not allowed, other synthesis systems or components 403 can be configured to choose a flip-flop option to construct the proposed RAM design if the flip-flop option is compatible with other options. In exemplary embodiments, the default cutoff value for this case is 5. In other embodiments, the default cutoff value for this case can be other than 5.

In one embodiment, when the width of a proposed RAM design is less than or equal to a predetermined cutoff value and the depth of the proposed RAM design is less than or equal to the predetermined cutoff value and a FIFO optimized latch array is allowed and a flip-flop RAM is not chosen, other synthesis systems or components 403 can be configured to choose the optimized latch array instead of a RAM design option that constructs the proposed RAM design using any combination of flip-flops, latches or RAM cells. In one embodiment, when the depth of the proposed RAM design is less than or equal to a predetermined cutoff and a FIFO optimized latch array is allowed and a RAM constructed out of flip-flops is not chosen, other synthesis systems or components 403 can be configured to choose to construct a FIFO optimized latch array instead of a RAM that uses any combination of flip-flops, latches or RAM cells. In exemplary embodiments, the default cutoff value can be 16. In other embodiments, the default cutoff value can be other than 16.

In one embodiment, other synthesis systems or components 403 can be configured to invoke system 401 to generate 1 master and N slave latches for FIFO optimized latch arrays when a FIFO depth is within a predetermined range having minimum and maximum values, if the FIFO optimized latch array is chosen by other synthesis systems or components 403. In one embodiment, the default minimum and maximum values is 1 . . . 0 (e.g., disabled).

In one embodiment, other synthesis systems or components 403 can invoke system 401 to generate multiple master-slave pairs rather than invoking another synthesis system to generate FIFO optimized latch arrays when the proposed FIFO depth is within a predetermined range with minimum and maximum values. This assumes that a FIFO optimized latch array option is chosen by the synthesis system and the FIFO has synchronous sequential write/read access. This embodiment is testable and uses a depth of 2 master-slave pairs. In one embodiment, the default can be 1 . . . 0 (e.g., disabled). In other embodiments the default can be other than 1 . . . 0. In one embodiment, other synthesis systems or components 403 can invoke system 401 to generate read-side bypass latches.

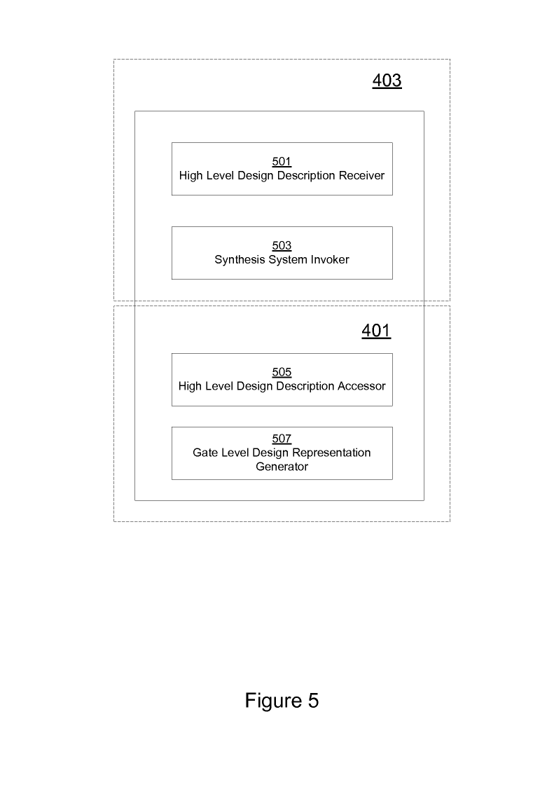

FIG. 5 shows components of a system 401 (e.g., 505 and 507) for automatically generating master-slave latch structures according to one embodiment. In one embodiment, components of system 401 implement an algorithm for generating master-slave latch structures. In the FIG. 5 embodiment, components of system 401 include high level design description accessor 505 and gate level design representation generator 507. Also shown in FIG. 5 are components of other synthesis systems or components 403 that are involved in instantiating system 401. These components include high level design description receiver 501 and synthesis system invoker 503.

High level design description receiver 501 receives, at a first synthesis system (e.g., other synthesis systems or components 403 in FIG. 4A), high level design descriptions for a master-slave structure design (e.g., flow control buffer design). In one embodiment, the high level design descriptions can include but are not limited to RTL code of the design, constraints on timing, area, etc., and a standard cell library. In one embodiment, the descriptions can indicate that the design is to include fully registered flow control.

Synthesis system invoker 503 invokes from the first synthesis system (e.g., other synthesis systems or components 403 in FIG. 4A), a second synthesis system based on a determination that a fully registered flow control design is involved. In one embodiment, the determination is based on information in the high level design descriptions.

High level design description accessor 505 accesses, at a second synthesis system (e.g., system 401 in FIG. 4A), the high level design descriptions received by high level design description receiver 501.

Gate level design representation generator 507 generates a gate level design representation that is derived from the high level design descriptions accessed by high level design description accessor 501. In one embodiment, the gate level design representation is implemented using master-slave latch pairs. In one embodiment, the gate level design representation is a master-slave latch structure design (e.g., flow control buffer) representation that when implemented provides fully registered flow control.

In one embodiment, components and operations of component 401 can be encompassed by components and operations of one or more computer programs (e.g., 403 in FIG. 4A). In another embodiment, components and operations of system 401 can be separate from the aforementioned one or more computer programs but can operate cooperatively with components and operations thereof.

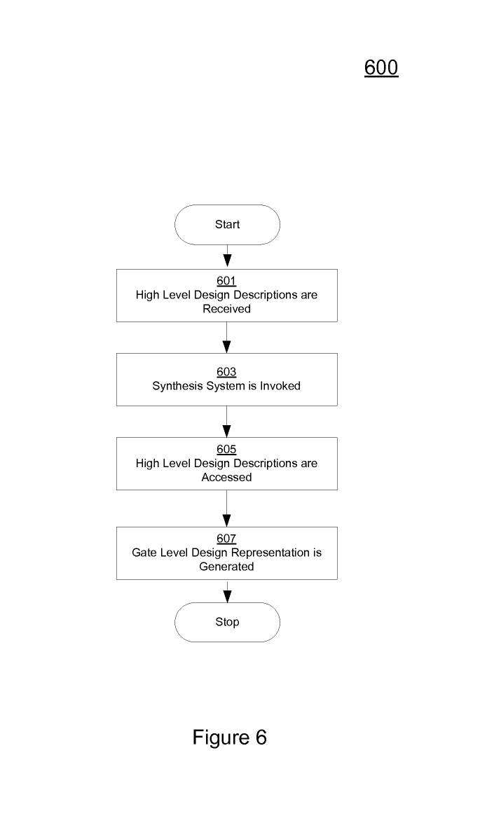

FIG. 6 shows a flowchart 600 of the operations performed in a method for automatically generating master-slave latch structures according to one embodiment. The flowcharts include processes that, in one embodiment can be carried out by processors and electrical components under the control of computer-readable and computer-executable instructions. Although specific operations are disclosed in the flowcharts, such operations are exemplary. That is the present embodiment is well suited to performing various other operations or variations of the operations recited in the flowchart.

Referring to FIG. 6, at 601, high level design description for a master slave structure are received, at a first synthesis system. In one embodiment, the high level design descriptions can include but are not limited to RTL code of the design, constraints on timing, area, etc., and a standard cell library. In one embodiment, the descriptions can indicate that the design is to include fully registered flow control.

At 603, from the first synthesis system, a second synthesis system is invoked based on a determination that fully registered flow control is involved. In one embodiment, the determination is based on information in the high level design descriptions that are received.

At 605, the high level design descriptions are accessed by the second synthesis system.

At 607, a gate level design representation is generated that is derived from the high level design descriptions. In one embodiment, the gate level design representation is implemented using master-slave latch pairs.

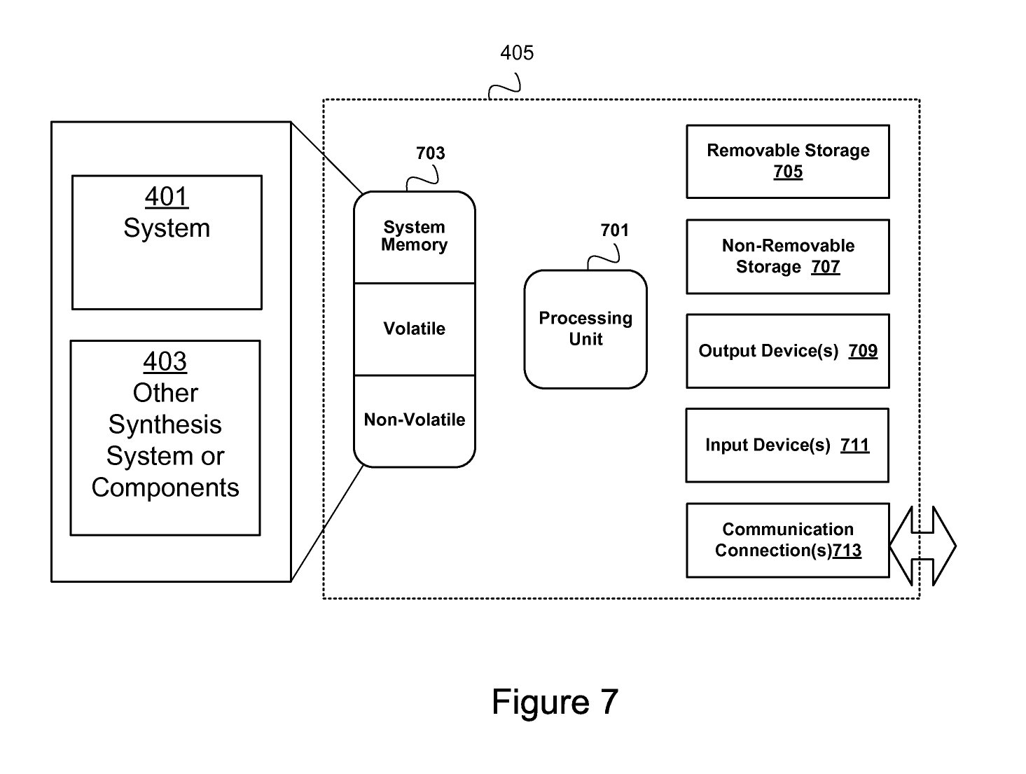

FIG. 7 shows an exemplary computing device 405 according to one embodiment. Computing device 405 typically includes at least some form of computer readable media. Computer readable media can be any available media that can be accessed by computing device 405 and can include but is not limited to computer storage media.

In its most basic configuration, computing device 405 typically includes processing unit 701 and memory 703. Depending on the exact configuration and type of computing device 405 that is used, memory 703 can be volatile (such as RAM), non-volatile (such as ROM, flash memory, etc.) or some combination of the two. In one embodiment, as shown in FIG. 4A, the herein described system 401 for generating master-slave latch structures and other synthesis systems and components can reside in system memory 703 (see description of these systems made with reference to FIG. 4A).

Additionally, computing device 405, can include mass storage systems (removable 705 and/or non-removable 707) such as magnetic or optical disks or tape. Similarly, computing device 405 can include output devices 709 and/or input devices 711 (e.g., such as a display). Additionally, computing device 405 can include network connections 713 to other devices, computers, networks, servers, etc. using either wired or wireless media. As all of these devices are well known in the art, they need not be discussed in detail.

With regard to exemplary embodiments thereof, systems and methods for automatically generating master-slave latch structures is disclosed. A method includes, from another logic synthesis system, that invokes a logic synthesis system for generating master-slave latch structures, accessing high level design descriptions of a master-slave latch structure, wherein the descriptions indicate that the design is to include fully registered flow control, and based on the high level design descriptions, generating a master-slave latch structure design to include at least one master-slave latch pair.

Although many of the components and processes are described above in the singular for convenience, it will be appreciated by one of skill in the art that multiple components and repeated processes can also be used to practice the techniques of the present invention. Further, while the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of components and should not be restricted to the ones mentioned above. It is therefore intended that the invention be interpreted to include all variations and equivalents that fall within the true spirit and scope of the present invention.

We claim:

1. In a logic synthesis system for automatically generating master-slave latch structures, a computer implemented method for automatically generating master-slave latch structure designs, the method comprising:
from another logic synthesis system, that invokes said logic synthesis system for automatically generating master-slave latch structures, accessing high level design descriptions of a master-slave latch structure that indicate a fully registered flow control structure design; and
based on said high level design descriptions, automatically generating a master-slave latch structure design to comprise at least one master-slave latch pair.

2. The method of claim 1 wherein said another logic synthesis system is one of a FIFO generator, a retiming flow and a plugin.

3. The method of claim 1 further comprising automatically invoking said logic synthesis system to generate components of interface senders and receivers, registered read sides and sequential memories.

4. The method of claim 1 wherein said logic synthesis system is invoked to generate an implicit retiming stage.

5. The method of claim 1 wherein said logic synthesis system is invoked to generate an explicit retiming stage.

6. The method of claim 1 wherein said master-slave latch structure design comprises a write data register.

7. The method of claim 1 wherein said master-slave latch structure design comprises one of a single master-slave latch pair and N/2 rows of master-slave latches.

8. In a logic synthesis platform, a computer implemented method for automatically generating a master-slave latch structure design, the method comprising:
receiving at a first logic synthesis system, high level design descriptions for a master-slave latch structure design that indicate a fully registered flow control structure design;
invoking from said first logic synthesis system, a second logic synthesis system based on a determination that fully registered flow control is involved;
accessing from said first logic synthesis system said high level design descriptions; and
based on said high level design descriptions, automatically generating said master-slave latch structure design that comprises at least one master-slave latch pair.

9. The method of claim 8 wherein said first logic synthesis system is one of a FIFO generator, a retiming flow and a plugin.

10. The method of claim 8 further comprising automatically invoking said second logic synthesis system to generate components of interface senders and receivers, registered read sides and sequential memories.

11. The method of claim 8 wherein said second logic synthesis system is invoked to generate an implicit retiming stage.

12. The method of claim 8 wherein said second logic synthesis system is invoked to generate an explicit retiming stage.

13. The method of claim 8 wherein said master-slave latch structure design comprises a write data register and a 1-deep RAM.

14. The method of claim 8 wherein said master-slave latch structure design comprises one of a single master-slave latch pair and N/2 rows of master-slave latch pairs.

15. A computer system, comprising:
memory;
at least one processer; and
a display component,
wherein said at least one processer executes, a method for automatically generating a master-slave latch structure design, comprising:
receiving at a first logic synthesis system, high level design descriptions for said master-slave latch structure design that indicate a fully registered flow control structure design;
invoking from said first logic synthesis system, a second logic synthesis system based on a determination that fully registered flow control is involved;
accessing at said second logic synthesis system said high level design descriptions for said master-slave latch structure; and
based on said high level design descriptions, automatically generating said master-slave latch structure design that comprises at least one master-slave latch pair.

16. The system of claim 15 wherein said first logic synthesis system is one of a FIFO generator, a retiming flow and a plugin.

17. The system of claim 15 further comprising invoking said second logic synthesis system to generate components of interface senders and receivers, registered read sides and sequential memories.

18. The system of claim 15 wherein said second logic synthesis system is invoked to generate an implicit retiming stage.

19. The system of claim 15 wherein said second logic synthesis system is invoked to generate an explicit retiming stage.

20. The system of claim 15 wherein said second logic synthesis system is invoked to generate an explicit retiming stage.
